(19) United States
(12) Patent Application Publication
(10) Pub. No.: US 2026/0035243 A1
(43) Pub. Date: Feb. 5, 2026

(54) SYSTEM AND METHOD FOR PRODUCTION OF ULTRA-HIGH PURITY OXYGEN

(71) Applicant: Henry E. Howard, Tonawanda, NY (US)

(72) Inventor: Henry E. Howard, Tonawanda, NY (US)

(21) Appl. No.: 19/269,156

(22) Filed: Jul. 15, 2025

Related U.S. Application Data
(60) Provisional application No. 63/678,214, filed on Aug. 1, 2024.

(51) Int. Cl. C01B 13/02; F25J 3/02; F25J 3/04; F25J 3/08

(52) U.S. Cl. CPC C01B 13/0248; F25J 3/0257; F25J 3/04412; F25J 3/04654; F25J 3/08; C01B 2210/0009; C01B 2210/0042; C01B 2210/0046; C01B 2210/007; C01B 2210/0082; C01P 2006/80; F25J 2200/06; F25J 2210/02; F25J 2210/40; F25J 2215/42; F25J 2215/56; F25J 2215/58; F25J 2220/50

(57) ABSTRACT

A system and method of ultra-high purity (UHP) oxygen production from an argon and oxygen producing cryogenic air separation unit incorporating a dedicated methane rejection column or column section having a liquid to vapor (L/V) ratio lower than the L/V ratio in the associated argon rectifier is provided.

### CROSS REFERENCE TO RELATED APPLICATIONS

This application claims the benefit of and priority to U.S. provisional patent application Ser. No. 63/678,214 filed on Aug. 1, 2024 the disclosure of which is incorporated by reference.

### TECHNICAL FIELD

The present system and method relates to production of ultra-high purity (UHP) oxygen from a cryogenic air separation unit, and more particularly, to the production of UHP oxygen from an oxygen and argon producing three column air separation unit.

### BACKGROUND

Current industrial gas product requirements for the electronics industry are calling for tighter constraints with respect to methane and other hydrocarbon content in the industrial gas product slates, which often include UHP oxygen products as well as argon products. A conventional cryogenic distillation approach for the production of UHP oxygen together with argon typically calls for the extraction of a side liquid draw from a rectification section of the lower pressure column in an argon producing air separation unit. The side draw is typically taken from an intermediate location of the lower pressure column or from the argon rectification section of the column. With respect the side liquid draw from the argon rectification section, the liquid draw to the UHP column is typically taken about 5 stages to 10 stages above the column feed point. The purpose of this positioning of the side liquid draw is the elimination or reduction of hydrocarbons such as methane in the liquid draw. This substantially methane-free liquid is then directed to a stripping section. Due low residual argon content specifications, this UHP stripping section will typically require a height greater than that of the associated stripping section in the lower pressure column of the air separation unit. Depending upon spatial positioning, the condensation of pressurized air or nitrogen are employed for column re-boil.

The above-described conventional approach for UHP oxygen production is generally considered effective and is easily integrated into the an oxygen and argon producing triple distillation column air separation cycle. However, implementation of the UHP oxygen approach or cycle carries with it an associated power and recovery penalty upwards of 2% (in terms of absolute loss) when using pressurized air for the UHP column re-boil. In addition to the incremental power, there is additional power and capital costs required for liquefaction. In addition, there is the additional capital cost of the UHP oxygen column, the condenser-reboiler in the UHP column and any associated piping results. Depending on the size of the plant, these additional costs for UHP oxygen production with argon can often exceed of one million dollars compared to the costs for standard purity oxygen and argon products.

Thus, there is a continuing need to improve ultra-high purity (UHP) oxygen production from a cryogenic air separation unit, and more specifically, there is a need to reduce the operational penalty and costs associated with conventional production of UHP oxygen from an oxygen and argon producing three column air separation unit.

### SUMMARY

In an effort to reduce the cost of UHP oxygen production, the use of a dedicated methane rejection column or column section having a liquid to vapor (L/V) ratio lower than the L/V ratio in the associated argon rectifier is proposed. The operation of a methane rejection column section or methane rejection column operating at a L/V ratio less than the L/V ratio in the associated argon column in air separation units configured to produce UHP oxygen differs from established prior art solutions. Moreover, the incorporation of a methane rejection column section into either the lower pressure column or the argon column to take a side draw of a methane free liquid to be delivered to the UHP column is not previously been deployed in the above-described conventional UHP applications by persons skilled in the art.

To that end, the present invention may be characterized as a distillation column system for production of ultra-high purity oxygen comprising: (i) a higher pressure column configured for receiving a liquid air stream, a gaseous air stream, and a higher pressure column reflux stream and to yield a nitrogen overhead, and a liquid kettle stream; (ii) a lower pressure column configured for receiving a portion of the liquid kettle stream from the higher pressure column and to produce one or more liquid oxygen streams, a gaseous nitrogen stream, a waste nitrogen stream, and an argon-rich side draw stream; (iii) a main condenser-reboiler disposed in the lower pressure column and configured to condense the nitrogen overhead from the higher pressure column against liquid oxygen in the lower pressure column to yield a liquid nitrogen condensate and an oxygen-rich boil off stream that is released into the lower pressure column, wherein a first portion of the liquid nitrogen condensate forms the nitrogen-rich reflux stream for the higher pressure column and a second portion of the liquid nitrogen condensate is directed to the lower pressure column as a lower pressure column reflux stream; (iv) a methane rejection column or column section configured to receive the argon-rich side draw stream and a methane rejection column reflux stream and yield a methane-free argon-rich vapor stream and an oxygen liquid bottoms that is returned to or released into the lower pressure column; (v) an argon column configured to receive the methane-free argon-rich vapor stream, an argon-rich reflux stream and to yield an argon-overhead and a methane-free oxygen-rich bottoms; (vi) an argon condenser configured to condense the argon overhead from the argon column against another portion of the liquid bottoms from the higher pressure column or an oxygen liquid stream from the one or more liquid oxygen streams from the lower pressure column to yield a liquid argon condensate, an oxygen rich vapor stream and an oxygen-rich liquid that are returned or released into the lower pressure column, wherein a first portion of the liquid argon condensate forms the argon-rich reflux stream for the argon column and a second portion of the liquid argon condensate is taken as a crude argon product stream; (vii) an ultra-high purity oxygen column or column section configured to receive the methane-free oxygen-rich bottoms and produce an ultra-high purity liquid oxygen product stream. In the preferred embodiment, the liquid to vapor (L/V) ratio in the methane rejection column or column section is lower than the liquid to vapor (L/V) ratio in the argon column.

Alternatively, the present invention may be characterized as a method of improving production of an ultra-high purity oxygen product stream comprising the step of rectifying air in a distillation column system to yield one or more liquid oxygen streams, a gaseous nitrogen stream, a waste nitrogen stream, and an argon-rich side draw stream, and a crude argon stream wherein the distillation column system comprises a higher pressure column, a lower pressure column, a main condenser-reboiler, and argon column, and an argon condenser and wherein an argon-rich side draw stream is taken from the lower pressure column and used to produce the crude argon stream from the argon column and argon condenser. The improvement being characterized by the steps of: (a) producing a methane-free argon-rich vapor stream from an argon-rich side draw stream in a methane rejection column or column section; (b) directing the methane-free argon-rich vapor stream to the argon column, wherein the argon column is configured to yield an argon-overhead and a methane-free oxygen-rich bottoms; and (c) directing the methane-free oxygen-rich bottoms to an ultra-high purity oxygen column or column section to produce an ultra-high purity liquid oxygen product stream.

In some embodiments, the ultra-high purity oxygen column or column section is disposed within the lower pressure column as a divided wall column section or alternatively configured as a standalone ultra-high purity oxygen column. When configured as a standalone ultra-high purity oxygen column, a first portion of the methane-free oxygen-rich bottoms is directed to the ultra-high purity oxygen column while a second portion of the methane-free oxygen-rich bottoms forms the methane rejection column reflux stream. The ultra-high purity oxygen column may also be configured with a re-boiler to form a boil off stream of high purity oxygen vapor that is returned or released into the standalone ultra-high purity oxygen column.

Likewise, in some embodiments the methane rejection column or column section is disposed within the lower pressure column or the argon column as a divided wall column section or alternatively as a standalone the methane rejection column. Where the methane rejection column is configured as a divided wall column section the oxygen liquid bottoms from the methane rejection divided wall column section is released into the lower pressure column. Alternatively, where the methane rejection column is configured as a standalone the methane rejection column, the oxygen liquid bottoms from the methane rejection column is preferably returned to the lower pressure column.

### BRIEF DESCRIPTION OF DRAWINGS

It is believed that the claimed invention will be better understood when taken in connection with the accompanying drawings in which:

FIG. 1 shows a schematic of the process flow diagram for an embodiment of the present system and method; and

FIG. 2 shows a schematic of the process flow diagram for another embodiment of the present system and method.

### DETAILED DESCRIPTION

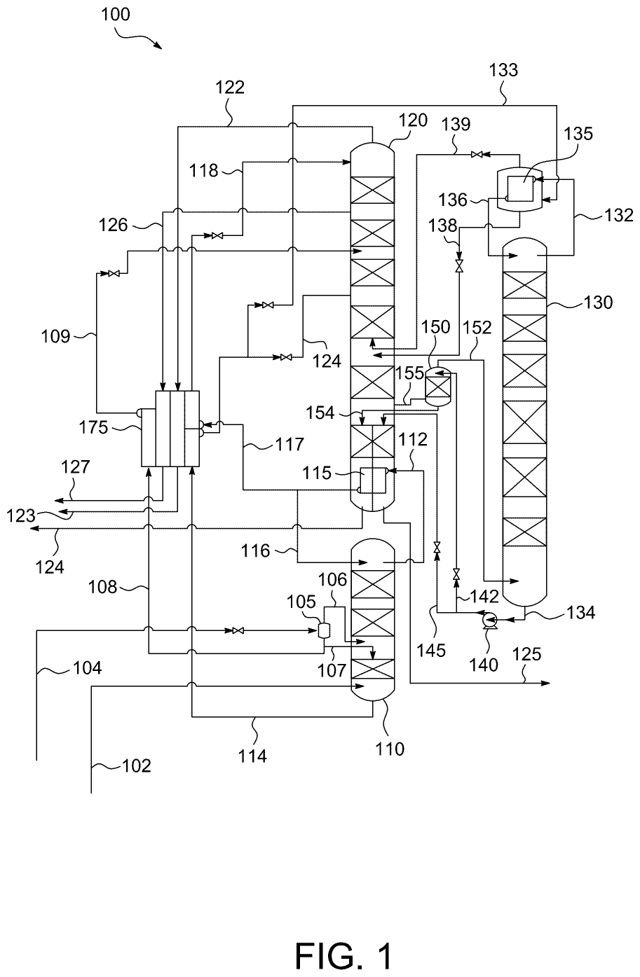

Turning now to the drawings, FIG. 1 depicts a triple column arrangement of a distillation column system for an air separation unit configured for the production of UHP oxygen and crude argon. The depicted distillation column arrangement is characterized by a the use of a methane rejection column 150 (or column section) together with a crude argon column 130 and wherein the methane rejection column 150 operates at an L/V ratio less than the L/V ratio of the argon rectification column. Another characterizing feature of the present three column arrangement is the use of a UHP production column section 121 preferably disposed in a lower portion of the lower pressure distillation column 120 of the distillation column system.

As seen in FIG. 1, a typical three column arrangement 100 for the cryogenic distillation and separation of air involves directing a compressed, pre-purified gaseous air stream 102 and a stream of pre-purified liquid air 104 to the higher pressure column 110 in the distillation column system of an air separation unit. In the illustrated embodiment, the liquid air stream 104 may be expanded in an expansion valve with the resulting two phase stream directed to a phase separator 105. The gaseous air stream 106 together with a first portion of the resulting liquid stream 107 exiting the phase separator 105 are fed together with the compressed, pre-purified gaseous air stream 102 into the higher pressure column 110. A second portion of the resulting liquid stream 108 is sub-cooled in heat exchanger 175 with the resulting sub-cooled liquid air stream 109 being further expanded in expansion valve and introduced into the lower pressure column 120 of the distillation column system.

Within the higher pressure column 110, the various air streams are rectified into a nitrogen-rich overhead 112 and an oxygen-rich kettle liquid bottoms 114. The nitrogen-rich overhead 112 is directed to a main condenser-reboiler 115 typically disposed in a lower section of the lower pressure column 120 where the nitrogen-rich overhead 112 is condensed against liquid oxygen. A portion of the condensed nitrogen stream 117 is sub-cooled in heat exchanger 175 and the resulting sub-cooled nitrogen is directed as a reflux stream 118 to the lower pressure column 120. Another portion of the condensed nitrogen stream is directed as a reflux stream 116 to the higher pressure column 110. The oxygen-rich kettle liquid bottoms 114 is also sub-cooled in heat exchanger 175 and split into two split-kettle streams, including a first split kettle stream 124 being expanded in expansion valve and introduced at an intermediate location of the lower pressure column 120 and a second split-kettle stream 133 being expanded in expansion valve and introduced as the condensing medium in the argon condenser 135.

Within the lower pressure column 120, the various input streams, including the sub-cooled liquid air stream 109, reflux stream 119, and split-kettle stream 124 streams are rectified to produce nitrogen overhead 122 and an oxygen liquid bottoms. In addition, a waste nitrogen stream 126 may also be taken from the lower pressure column several stages below the top of the lower pressure column 120. The nitrogen overhead 122 is warned in heat exchanger 175 and taken as a gaseous nitrogen product stream whereas the oxygen liquid bottoms 124 may be taken as liquid oxygen products. As described in more detail below, the oxygen liquid products include a normal purity or high purity liquid oxygen product stream 124 and a UHP liquid oxygen product stream 125. The waste nitrogen stream 126 is also warmed in heat exchanger 175 to yield a warmed waste nitrogen stream 127 which may be used to produce additional refrigeration via a waste nitrogen expansion circuit and/or used to regenerate pre-purification units associated with the air separation unit.

The illustrated three column arrangement also includes a crude argon column 130 and argon condenser 135. The crude argon column 130 is configured to receive an argon enriched low pressure draw 155 from the lower pressure column 120. The argon-enriched stream introduced into the crude argon column 152 and is rectified to produce an argon depleted liquid bottoms 134 and an argon-rich overhead 132. The argon-rich overhead 132 is directed to the argon condenser 135 where it is condensed against kettle liquid from the second split-kettle stream 133 to yield a crude liquid argon stream 136, and a boil-off stream 139. The boil-off stream 139 and any excess condensing liquid from the argon condenser 135 are returned to an intermediate location of the lower pressure column 120. All or a portion of the crude liquid argon stream 136 is directed as an argon reflux stream to the crude argon column 130. A portion of the argon-rich overhead 132 or a portion of the crude liquid argon stream 136 is preferably taken for further argon refining.

As indicated above, one of the differentiating features of this three column arrangement 100 for separation of air is the division of the argon depleted liquid bottoms 134 from the crude argon rectification column 130 into a reflux stream 142 for a methane rejection column 150 (or column section) and an argon-depleted return stream 145 directed to the UHP production column section 121 within the lower pressure column. Another differentiating feature of this three column arrangement 100 is the operation of methane rejection column 150 at a reflux ratio or L/V ratio substantially below that of the L/V ratio of the crude argon rectification column 130. Yet another differentiating features of this three column arrangement 100 is the integration of the UHP production column section 121 within the lower pressure column, preferably as a divided wall column arrangement.

Simple evaluation of the process configuration for conventional UHP oxygen production in distillation column systems of an air separation unit indicates that the methane rejection portion of the lower pressure column design is operated at an L/V ratio of approximately equal to the associated L/V ratio of the argon rectification column (e.g. L/V ratio >0.95). Consequently, the oxygen concentration of the methane rejection section is depleted in oxygen relative to the feed content. Upon introduction of the liquid draw into the UHP column, the reduced oxygen content results in higher pinch point and a lower L/V ratio in the stripping sections. This in turn results in lower potential UHP oxygen extraction as well as higher column traffic. Since the relative volatility of methane relative to argon and oxygen is greater than about 3.5 at or near ambient pressure. The minimum L/V ratio for simple methane rejection is about 0.28. Operation of a methane rejection column with an L/V ratio substantially less than that of the argon rejection column but above the minimum L/V ratio for simple methane rejection limits the reduction in oxygen content in the resulting liquid draw.

Unlike conventional three column arrangements, the argon enriched low pressure draw 155 from the lower pressure column 120 is first directed to a methane rejection column 150 or small additional rectification section for methane rejection. Using the methane rejection column 150, the overhead concentration of methane and other hydrocarbons can be easily reduced to part per billion (ppb) levels. The reflux ratio or L/V ratio for the methane rejection column 150 will depend upon the number of contained stages. In general, a reflux ratio or L/V ratio in a range of about 0.3 to about 0.8 is preferred. More preferably, the reflux ratio or L/V ratio in the methane rejection column 150 will be in the range of about 0.4 to about 0.6.

The overhead vapor 152 of the methane rejection column 150 is then directed to the crude argon rectification column 130. The crude argon rectification column 130 serves to substantially eliminate oxygen from the overhead vapor 152 of the methane rejection column 150 for purposes of crude argon production. Additional refining of the crude argon is not shown in FIG. 1 but may be also included as necessary. The argon depleted bottoms liquid 134 of the crude argon rectification column 130 is also essentially free of methane. Typically, a mechanical pump 140 will be employed to return this methane-free bottoms liquid to an intermediate location of the lower pressure distillation column 120. A first portion of the argon depleted bottoms liquid 142 from the crude argon rectification column 130 is also used to reflux the methane rejection column 150 whereas the remainder portion of the argon depleted bottoms liquid 145 from the crude argon rectification column 130 is directed to the UHP production column section 121 of the lower pressure distillation column 120. In this adaptation, the UHP production column section 121 is preferably incorporated into the lower portion of the lower pressure distillation column 120, and more preferably as a divided wall column arrangement. The UHP oxygen product stream 125 is taken from the bottom of the UHP production column section 121 in the lower pressure column 120.

In addition, a segregated UHP main condenser-reboiler may also be optionally included in this configuration. Alternatively, this UHP column section may be physically separated from the lower pressure column as an independent UHP column and operated independently. As a further alternative, additional UHP staging may be employed in the lower pressure column shell to reach a very low argon content in the UHP oxygen product stream taken from the bottom of the UHP production column section. Such divided wall UHP column arrangement, independent UHP column arrangement, or additional UHP column sections may employ an independent reboiler using pressurized fluids such as pressurized air or nitrogen.

As a further alternative, the methane rejection column may also be incorporated into the lower pressure column shell as either a divided wall column or as additional methane rejection sections within the lower pressure column. In this alternative configuration, the methane rejection column or column sections may be operated physically adjacent to the nitrogen stripping section of the lower pressure column.

The critical common elements or features in these proposed alternative configurations still involves the division of the argon depleted liquid bottoms 134 from the crude argon rectification column 130 into a reflux stream 142 for the methane rejection column 150 and an argon-depleted return stream 145 directed to the UHP production column section 121 as well as the operation of methane rejection column 150 at a reflux ratio or L/V ratio substantially below that of the L/V ratio of the crude argon rectification column 130.

Additional embodiments of the present triple column arrangement may include the use of separate reflux lines for the crude argon bottoms and perhaps the use of separate pumps. Alternatively, the methane rejection column may be integrated into the crude argon column shell although such alternative arrangement may require additional pumps to facilitate the required flows.

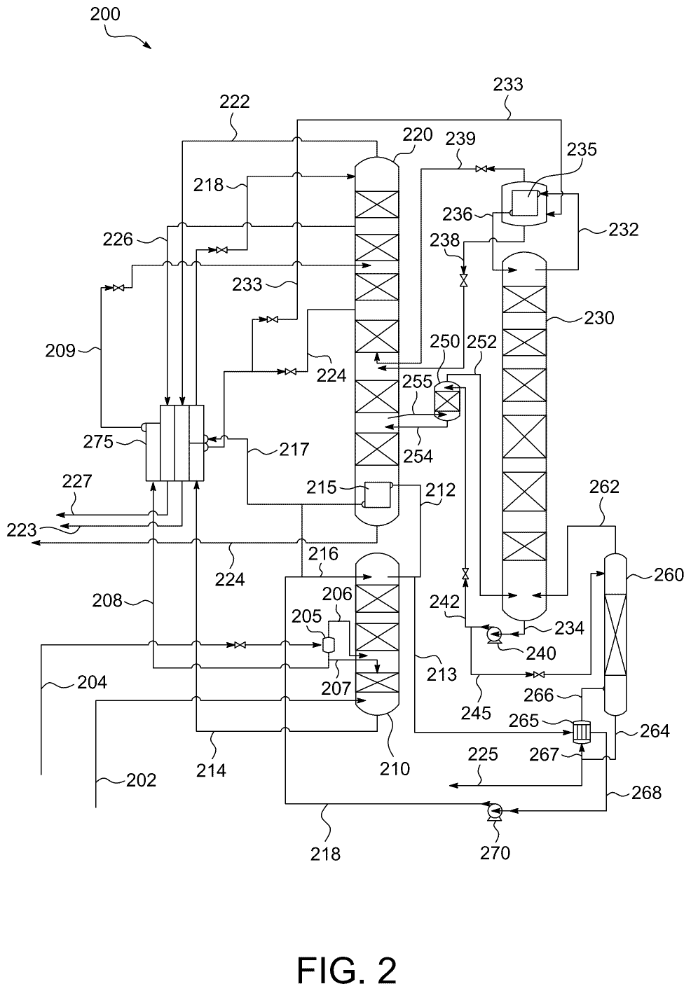

FIG. 2 depicts another embodiment of the triple column arrangement of a distillation column system for an air separation unit configured for the production of UHP oxygen and crude argon that uses a more conventional UHP argon stripping column 260. The depicted distillation column arrangement in FIG. 2 is also characterized by a the use of a methane rejection column 250 together with a crude argon column 230 and wherein the methane rejection column 250 operates at an L/V ratio less than the L/V ratio of the argon rectification column in order to maximize the UHP oxygen production.

As seen in FIG. 2, a typical three column arrangement 200 for the cryogenic distillation and separation of air involves directing a compressed, pre-purified gaseous air stream 202 and a stream of pre-purified liquid air 204 to the higher pressure column 210 in the distillation column system of an air separation unit. In the illustrated embodiment, the liquid air stream 204 may be expanded in an expansion valve with the resulting two phase stream directed to a phase separator 205. The gaseous air stream 206 together with a first portion of the resulting liquid stream 207 exiting the phase separator 205 are fed together with the compressed, pre-purified gaseous air stream 202 into the higher pressure column 210. A second portion of the resulting liquid stream 208 is sub-cooled in heat exchanger 275 with the resulting sub-cooled liquid air stream 209 being further expanded in expansion valve and introduced into the lower pressure column 220 of the distillation column system.

Within the higher pressure column 210, the various air streams are rectified into a nitrogen-rich overhead 212 and an oxygen-rich kettle liquid bottoms 214. The nitrogen-rich overhead 212 is directed to a main condenser-reboiler 215 typically disposed in a lower section of the lower pressure column 220 where the nitrogen-rich overhead 212 is condensed against liquid oxygen. A portion of the condensed nitrogen stream 217 is sub-cooled in heat exchanger 275 and the resulting sub-cooled nitrogen is directed as a reflux stream 218 to the lower pressure column 120. Another portion of the condensed nitrogen stream is directed as a reflux stream 216 to the higher pressure column 210. The oxygen-rich kettle liquid bottoms 214 is also sub-cooled in heat exchanger 275 and split into two split-kettle streams, including a first split kettle stream 224 being expanded in expansion valve and introduced at an intermediate location of the lower pressure column 220 and a second split-kettle stream 233 being expanded in expansion valve and introduced as the condensing medium in the argon condenser 235.

Within the lower pressure column 220, the various input streams, including the sub-cooled liquid air stream 209, reflux stream 219, and split-kettle stream 224 streams are rectified to produce nitrogen overhead 222 and an oxygen liquid bottoms. In addition, a waste nitrogen stream 226 may also be taken from the lower pressure column several stages below the top of the lower pressure column 220. The nitrogen overhead 222 is warned in heat exchanger 275 and taken as a gaseous nitrogen product stream whereas the oxygen liquid bottoms 224 may be taken as liquid oxygen products. As described in more detail below, the oxygen liquid products include a normal purity or high purity liquid oxygen product stream 224 and a UHP liquid oxygen product stream 225. The waste nitrogen stream 226 is also warmed in heat exchanger 275 to yield a warmed waste nitrogen stream 227 which may be used to produce additional refrigeration via a waste nitrogen expansion circuit and/or used to regenerate pre-purification units associated with the air separation unit.

Similar to the embodiment shown in FIG. 1, the illustrated three column arrangement 200 depicted in FIG. 2 also includes a crude argon column 230 and argon condenser 235. The crude argon column 230 is configured to receive an argon enriched low pressure draw 255 from the lower pressure column 220. The argon-enriched stream introduced into the crude argon column 252 and is rectified to produce an argon depleted liquid bottoms 234 and an argon-rich overhead 232. The argon-rich overhead 232 is directed to the argon condenser 235 where it is condensed against kettle liquid from the second split-kettle stream 233 to yield a crude liquid argon stream 236, and a boil-off stream 239. The boil-off stream 239 and any excess condensing liquid 238 from the argon condenser 235 are returned to an intermediate location of the lower pressure column 220. All or a portion of the crude liquid argon stream 236 is directed as an argon reflux stream to the crude argon column 230. A portion of the argon-rich overhead 232 or a portion of the crude liquid argon stream 236 is preferably taken for further argon refining.

Again, one of the differentiating features of this three column arrangement 200 for separation of air is the division of the argon depleted liquid bottoms 234 from the crude argon rectification column 230 into a reflux stream 242 for a methane rejection column 250 and an argon-depleted feed stream 245 directed to the UHP argon stripping column 260. Another differentiating feature of this three column arrangement 200 is the operation of methane rejection column 250 at a reflux ratio or L/V ratio substantially below that of the L/V ratio of the crude argon rectification column 230 to maximize UHP oxygen production.

Unlike conventional three column arrangements, the argon enriched low pressure draw 255 from the lower pressure column 220 is first directed to a methane rejection column 250 or small additional rectification section for methane rejection. Using the methane rejection column 250, the overhead concentration of methane and other hydrocarbons can be easily reduced to part per billion (ppb) levels. The reflux ratio or L/V ratio for the methane rejection column 150 will depend upon the number of contained stages. In general, a reflux ratio or L/V ratio in a range of about 0.3 to about 0.8 is preferred. More preferably, the reflux ratio or L/V ratio in the methane rejection column 250 will be in the range of about 0.4 to about 0.6.

The overhead vapor 252 of the methane rejection column 250 is then directed to the crude argon rectification column 230. The crude argon rectification column 230 serves to substantially eliminate oxygen from the overhead vapor 252 of the methane rejection column 250 for purposes of crude argon production. The argon depleted bottoms liquid 234 of the crude argon rectification column 230 is also essentially free of methane. Typically, a mechanical pump 240 will be employed to deliver this methane-free bottoms liquid to the desired locations. A first portion of the pumped argon depleted bottoms liquid 242 from the crude argon rectification column 230 is also used to reflux the methane rejection column 250 whereas the remainder portion of the pumped argon depleted bottoms liquid from the crude argon rectification column 230 is directed to the UHP argon stripping column 260 as the argon depleted feed stream 245. The UHP argon stripping column 260 strips argon from the feed stream to yield an argon containing overhead 262 and UHP oxygen bottoms 264. A first portion of the UHP oxygen bottoms 264 is directed as stream 267 to reboiler 265 where it is reboiled against a portion of the pressurized nitrogen-rich overhead 213 from the higher pressure column 210. The resulting UHP oxygen vapor stream 266 is returned to the UHP argon stripping column 260 while the resulting condensed nitrogen-rich stream 268 is pumped via pump 270, and the pumped liquid nitrogen stream 218 is combined with reflux stream 216 and directed to the higher pressure column 210. A second portion of the UHP oxygen bottoms 264 is taken as the UHP oxygen product stream.

Although, the above described and illustrated UHP oxygen cycles contemplate the production of UHP oxygen as a liquid product, this need not be the case. Any portion of the UHP oxygen liquid may be subjected to further processing. For instance, a portion of the UHP oxygen may be pumped and vaporized at elevated pressure within the main heat exchanger of the air separation unit against condensing high-pressure fluids such as air or nitrogen. Any portion of the UHP oxygen may also be combined with the primary oxygen product products or used as a surrogate for conventional purity oxygen.

While the present systems and methods have been described with reference to several preferred embodiments, it is understood that numerous additions, changes, and omissions can be made without departing from the spirit and scope of the present inventions as set forth in the appended claims.

What is claimed is:

1. A distillation column system for production of ultra-high purity oxygen comprising:
a higher pressure column configured for receiving a liquid air stream, a gaseous air stream, and a higher pressure column reflux stream and to yield a nitrogen overhead, and a liquid kettle stream;
a lower pressure column configured for receiving a portion of the liquid kettle stream from the higher pressure column and to produce one or more liquid oxygen streams, a gaseous nitrogen stream, a waste nitrogen stream, and an argon-rich side draw stream;
a main condenser-reboiler disposed in the lower pressure column and configured to condense the nitrogen overhead from the higher pressure column against liquid oxygen in the lower pressure column to yield a liquid nitrogen condensate and an oxygen-rich boil off stream that is released into the lower pressure column, wherein a first portion of the liquid nitrogen condensate forms the nitrogen-rich reflux stream for the higher pressure column and a second portion of the liquid nitrogen condensate is directed to the lower pressure column as a lower pressure column reflux stream;
a methane rejection column or column section configured to receive the argon-rich side draw stream and a methane rejection column reflux stream and yield a methane-free argon-rich vapor stream and an oxygen liquid bottoms that is returned to or released into the lower pressure column;
an argon column configured to receive the methane-free argon-rich vapor stream, an argon-rich reflux stream and to yield an argon-overhead and a methane-free oxygen-rich bottoms;
an argon condenser configured to condense the argon overhead from the argon column against another portion of the liquid bottoms from the higher pressure column or an oxygen liquid stream from the one or more liquid oxygen streams from the lower pressure column to yield a liquid argon condensate, an oxygen rich vapor stream and an oxygen-rich liquid that are returned or released into the lower pressure column, wherein a first portion of the liquid argon condensate forms the argon-rich reflux stream for the argon column and a second portion of the liquid argon condensate is taken as a crude argon product stream;
an ultra-high purity oxygen column or column section configured to receive the methane-free oxygen-rich bottoms and produce an ultra-high purity liquid oxygen product stream.

2. The distillation column system of claim 1 wherein a liquid to vapor (L/V) ratio in the methane rejection column or column section is lower than the liquid to vapor (L/V) ratio in the argon column.

3. The distillation column system of claim 1 wherein the ultra-high purity oxygen column or column section is disposed within the lower pressure column as a divided wall column section.

4. The distillation column system of claim 1 wherein the ultra-high purity oxygen column or column section is a standalone ultra-high purity oxygen column.

5. The distillation column system of claim 4 wherein the ultra-high purity oxygen column is configured to receive a first portion of the methane-free oxygen-rich bottoms and a second portion of the methane-free oxygen-rich bottoms forms the methane rejection column reflux stream

6. The distillation column system of claim 4 further comprising a reboiler configured to re-boil some of the ultra-high purity liquid oxygen to form a boil off stream and return or release the ultra-high purity boil-off stream into the standalone ultra-high purity oxygen column.

7. The distillation column system of claim 1 wherein the methane rejection column or column section is disposed within the lower pressure column as a divided wall column section and the oxygen liquid bottoms from the methane rejection divided wall column section is released into the lower pressure column.

8. The distillation column system of claim 1 wherein the methane rejection column or column section is a standalone the methane rejection column and the oxygen liquid bottoms from the methane rejection column is returned to the lower pressure column.

9. The distillation column system of claim 1 wherein the methane rejection column or column section is disposed in the argon column as a divided wall section.

10. A method of improving production of an ultra-high purity oxygen product stream comprising the steps of:
rectifying air in a distillation column system to yield one or more liquid oxygen streams, a gaseous nitrogen stream, a waste nitrogen stream, and an argon-rich side draw stream, and a crude argon stream
wherein the distillation column system comprises a higher pressure column, a lower pressure column, a main condenser-reboiler, and argon column, and an argon condenser; and
wherein an argon-rich side draw stream is taken from the lower pressure column and used to produce the crude argon stream from the argon column and argon condenser;
the improvement characterized by the steps of:
producing a methane-free argon-rich vapor stream from an argon-rich side draw stream in a methane rejection column or column section;
directing the methane-free argon-rich vapor stream to the argon column, wherein the argon column is configured to yield an argon-overhead and a methane-free oxygen-rich bottoms;
directing the methane-free oxygen-rich bottoms to an ultra-high purity oxygen column or column section to produce an ultra-high purity liquid oxygen product stream; and
wherein a liquid to vapor (L/V) ratio in the methane rejection column or column section is lower than the liquid to vapor (L/V) ratio in the argon column.

11. The method of claim 10, wherein the ultra-high purity oxygen column or column section is disposed within the lower pressure column as a divided wall column section.

12. The method of claim 10, wherein the ultra-high purity oxygen column or column section is a standalone ultra-high purity oxygen column.

13. The method of claim 12, wherein the methane-free oxygen-rich bottoms is split into a first portion of the methane-free oxygen-rich bottoms that is directed to the standalone ultra-high purity oxygen column and a second portion of the methane-free oxygen-rich bottoms that is directed to the methane rejection column as a methane rejection column reflux stream.

14. The method of claim 12, further comprising the steps of re-boiling some of the ultra-high purity liquid oxygen to form a boil off stream and returning or releasing the ultra-high purity boil-off stream into the standalone ultra-high purity oxygen column.

15. The method of claim 10, wherein the methane rejection column or column section is disposed within the lower pressure column as a divided wall column section.

16. The method of claim 10, wherein the methane rejection column or column section is a standalone the methane rejection column.

17. The method of claim 10, wherein the methane rejection column or column section is disposed in the argon column as a divided wall section.
